(19) United States
(12) Patent Application Publication
(10) Pub. No.: US 2012/0250918 A1
(43) Pub. Date: Oct. 4, 2012

(54) METHOD FOR IMPROVING THE COMPREHENSIBILITY OF SPEECH WITH A HEARING AID, TOGETHER WITH A HEARING AID

(75) Inventors: Sebastian PAPE, Erlangen (DE); Maja SERMAN, Erlangen-Buckenhof (DE)

(73) Assignee: SIEMENS MEDICAL INSTRUMENTS PTE. LTD., Singapore (SG)

(21) Appl. No.: 13/437,048

(22) Filed: Apr. 2, 2012

(30) Foreign Application Priority Data
Mar. 31, 2011 (DE) 102011006515.6

(51) Int. Cl. H04R 25/00

(52) U.S. Cl. 381/316

(57) ABSTRACT

The understanding of speech is to be improved in cases of hearing loss in which certain frequency ranges can no longer be perceived. A hearing aid has an input transducer for receiving an input signal and converting it into an electrical input signal, a signal processing unit for processing the electrical input signal and effecting frequency-dependent amplification of it, and generates an electrical output signal, and an output transducer for converting the electrical output signal into an acoustic output signal. The hearing aid further has a sound detector device for recognizing sounds in a voice signal coming into the hearing aid, a lookup table, in which a specific output code is assigned in each instance to certain sounds, and a coding device, by which the sounds contained in the electrical input signal are replaced by associated output code in the electrical output signal.

### CROSS-REFERENCE TO RELATED APPLICATION

This application claims the priority, under 35 U.S.C. §119, of German application DE 10 2011 006 515.6, filed Mar. 3, 2011; the prior application is herewith incorporated by reference in its entirety.

### BACKGROUND OF THE INVENTION

### Field of the Invention

The invention relates to a method for operating a hearing aid, together with a hearing aid with an input transducer for receiving an input signal and converting it into an electrical input signal, a signal processing unit for processing the electrical input signal and effecting frequency-dependent amplification of it, and for generating an electrical output signal, and an output transducer for converting the electrical output signal into an output signal which the user can perceive as an acoustic output signal.

For many of those with damaged hearing, the problem thus arises that, even when they are provided with a hearing aid having a high level of volume and amplification, they can no longer perceive certain frequency ranges. In the perception of speech this leads to certain sounds not being correctly understood, in particular consonants which in terms of speech have signal components which are in the high frequency signal spectrum. This particularly affects the so-called fricatives, which are named after the way they are articulated, for example “s”, “sh”, “v” or “z”.

A known way of compensating for the hearing losses described is to displace (transpose) the frequency ranges affected into other frequency ranges, which can be better perceived. In performing a frequency transposition of this type, two main methods are distinguished: in the case of frequency displacement, a frequency range (e.g. 4 kHz-6 kHz) is shifted into another frequency range (e.g. 2 KHz-4 kHz). In contrast to this, in the case of frequency compression the frequency of the output signal is produced by multiplying the frequency of the input signal by a factor (e.g. 0.75). Often however, frequency compression is not effected with 0 Hz as the starting point, but only above a certain frequency (the knee point) e.g. 2 kHz.

A method for frequency transposition in a hearing aid, together with a hearing aid for carrying out a frequency transposition, are known from the published, European patent application EP 1 441 562 A2.

Frequency transposition has two main disadvantages: on the one hand in respect of the spectrum, corruption of the original spectral composition of certain consonants and other sounds and, on the other hand, the ability to distinguish different fricatives—which affects their perception—is significantly impaired.

From the prior art, methods for voice signal processing are known by which the vowels or consonants can be recognized in a voice signal. For example, published, German utility model DE 691 05 154 T2 discloses a method of this type with which a voice signal spectrum is analyzed for the purpose of determining peak and average values, which are compared with certain threshold values to recognize vowels and consonants.

Also, such a method is known from U.S. patent publication No. U.S. 2009/0112594 A1 whereby pre-vowel consonants and post-vowel consonants are distinguished on the basis of acoustic models.

A method for a hearing aid is known from U.S. patent publication No. 2011/0004468 A1, in which sound segments, e.g. consonants or vowels, are detected and a multiplication factor is determined from a table, based on the respective type of sound segment, and used to adjust the time resolution of the sound segment.

### SUMMARY OF THE INVENTION

It is the objective of the present invention to improve the comprehension of speech in the case of hearing loss where certain frequency ranges can no longer be perceived even at high volumes or with high levels of amplification.

With the foregoing and other objects in view there is provided, in accordance with the invention a hearing aid. The hearing aid contains an input transducer for receiving an input signal and converting the input signal into an electrical input signal, a signal processing unit for processing and frequency-dependent amplification of the electrical input signal and for generating an electrical output signal, an output transducer for converting the electrical output signal into an output signal which can be perceived by a user as an acoustic output signal, a sound detection device for recognizing sounds in a voice signal coming into the hearing aid, and a lookup table in which a specific output code is stored in each instance for certain sounds. A spectrum of the specific output code is narrower than a spectrum of an associated sound and/or the spectrum of the specific output code is displaced towards lower frequencies compared with the spectrum of the associated sound. A coding device is provided, by which sounds contained in the electrical input signal can be replaced in each instance by the specific output code in the electrical output signal.

A hearing aid in accordance with the invention is to be understood as any device which supplies an output signal which can be perceived by a user as an acoustic signal, or contributes to the supplying of such an output signal, and which provides facilities which act as or contribute towards compensation for an individual loss of hearing in the user. In particular, this will be a hearing aid which can be worn on, or can be wholly or partially implanted in, the body or the head, in particular on or in the ear. However, it also includes devices whose primary purpose is not to compensate for a hearing loss, for example electronic entertainment devices (TVs, hi-fi systems, MP3 players etc.), or communication devices (mobile telephones, PDAs, headsets etc.) which do however provide means for compensating for an individual loss of hearing.

In general, a hearing aid incorporates an input transducer for receiving an input signal. The input transducer will, for example, be in the form of a microphone which receives an acoustic signal and converts it into an electrical input signal. However, it is also possible to regard as the input transducer units which have a coil or an antenna and which receive an electromagnetic signal and convert it into an electrical input signal. Furthermore, a hearing aid conventionally incorporates a signal processing unit for processing and effecting frequency-dependent amplification of the electrical input signal. For the purpose of signal processing in the hearing aid, use will be made of a signal processor, preferably digital (a DSP), whose method of working can be influenced by programs or parameters which can be transmitted to the hearing aid. This enables the signal processing unit's way of working to be adapted, both for the individual loss of hearing of a hearing aid wearer and also for the current hearing situation in which the hearing aid is currently being operated. The electrical input signal which has been modified in this way is finally fed to an output transducer. This is generally in the form of an earpiece which converts the electrical output signal into an acoustic signal. However, here again other forms of embodiment are possible, e.g. an implantable output transducer which is directly linked to the auditory ossicles and which excites vibrations in them.

In accordance with the invention, in addition to the conventional components (input transducer, signal processing unit, output transducer), the hearing aid has a sound detection device for the purpose of detecting sounds, in particular consonants or fricatives, in a voice signal coming into the hearing aid. The inventive hearing aid also has a lookup table (code book), which is stored for example in a memory and in which a specific output code is assigned in each instance to certain sounds or consonants. The inventive hearing aid also has a coding device, by which the sounds or consonants contained in the input signal are replaced by the associated output code in the resulting output signal.

In general terms, a sound is a noise or tone produced by a human or animal voice. In general speech science, a sound in the more narrow sense is a defined sound wave produced by a flow of breath (phonation airstream) with a particular adjustment of the speech organs. The generation and perception of sounds is the subject of phonetics. A speech sound, or phone, is here regarded as the smallest phonetic unit of spoken language.

In the sense of the invention, a consonant is to be understood generally as a sound, the articulation of which includes a narrowing of the vocal passage, so that the airstream from the breath is totally or partially blocked and audible turbulences (air eddies) are produced. Consonants are sounds which overcome a hindrance. In particular, in the sense of the invention consonants are not restricted to the consonant letters (B, C, D, F etc.).

With one preferred form of embodiment of the invention, so-called fricatives can be recognized by the sound detection device. A specific output code is then advantageously stored in the lookup table for every fricative.

The output codes are preferably such that certain spectral components, which are present in a sound or consonant, are no longer present in the associated output code. Generally the spectrum of an output code is also “narrower” than the spectrum of the associated consonant. Thus a type of frequency compression takes place for the consonants.

With one preferred form of embodiment of the invention, the output codes are adapted for a user's individual hearing loss. This means that every output code contains signal components in a frequency range which can still be perceived effectively by the user with the hearing aid.

The invention has the advantage that, unlike with conventional frequency compression, speech clarity is not significantly impaired.

Other features which are considered as characteristic for the invention are set forth in the appended claims.

Although the invention is illustrated and described herein as embodied in a method for improving the comprehensibility of speech with a hearing aid, together with a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified block diagram of a hearing aid in accordance with the prior art;

FIG. 2 is a block diagram to determine an output signal from an input signal; and

FIG. 3 are graphs showing a signal spectra during code conversion.

### DETAILED DESCRIPTION OF THE INVENTION

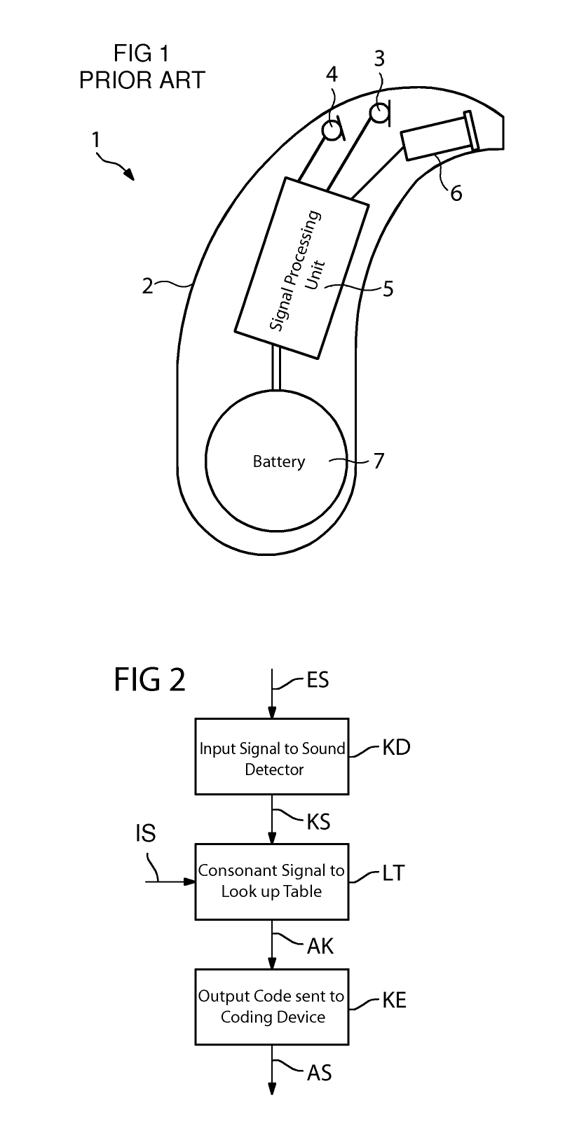

Referring now to the figures of the drawing in detail and first, particularly, to FIG. 1 thereof, there is shown a greatly simplified block diagram of the structure of a hearing aid in accordance with the prior art. In principle, hearing aids have as their essential components one or more input transducers, an amplifier and an output transducer. In general, the input transducer is a sound receiver, e.g. a microphone, or an electromagnetic receiver, e.g. an induction coil. The output transducer is mostly realized as an electro-acoustic transducer, e.g. a miniature loudspeaker or earpiece, as appropriate, or as an electro-mechanical transducer, e.g. a bone conduction earpiece. The amplifier is commonly integrated into a signal processing unit. This structural principle is illustrated in FIG. 1 by an example of a behind-the-ear hearing aid 1. Built into a hearing aid housing 2 which is to be worn behind the ear are two microphones 3 and 4 for the purpose of receiving the sound from the surroundings. A signal processing unit 5, which is also integrated into the hearing aid housing 2, processes the microphone signals and amplifies them. The output signal from the signal processing unit 5 is transmitted to a loudspeaker or earpiece 6, as applicable, which outputs an acoustic signal. If necessary, this sound is transmitted through a sound tube, which is fixed in the auditory canal using an otoplastic, to the eardrum of the hearing aid wearer. The power supply for the hearing aid, and in particular that for the signal processing unit 5, is effected by a battery 7 which is also integrated into the hearing aid housing 2.

FIG. 2 shows a greatly simplified block diagram of how an output signal is determined from an electrical input signal ES, which contains a voice signal. To this end the electrical input signal ES, for example a microphone signal or a signal resulting from a microphone signal after signal processing, is first supplied to a sound detection device KD for recognizing sounds, in particular consonants or fricatives, as appropriate, in the voice signal. It extracts sounds contained in the voice signal in the known manner and generates a corresponding consonant signal KS. The consonant signal KS is then fed to a lookup table LT, in which a specific output code AK is stored in each instance for different sounds or consonants contained in the consonant signal KS. The output codes AK assigned to certain sounds or consonants can advantageously be specified by programming the lookup table LT. The lookup table can be written to or modified by an input signal IS for this purpose. The output codes AK in the lookup table LT are in particular selected so that the resulting acoustic output signals can be readily perceived by a user with an individual hearing loss.

A determined output code AK is finally supplied to a coding device KE, which replaces the sounds and consonants that are contained and can be detected in the input signal in each instance with the associated output code AK in the resulting electrical output signal AS. The resulting output signal AS is finally converted by the relevant hearing aid into an acoustic output signal and emitted—optionally after further signal processing.

At least the sound detection in the sound detection device KD and the determination of an output code AK stored for a certain sound preferably take place in the frequency domain, so that a transformation of the electrical input signal ES from the time domain into the frequency domain, and optionally a back transformation, are required. These are advantageously executed in a manner known per se by an FFT or inverse FFT (IFFT).

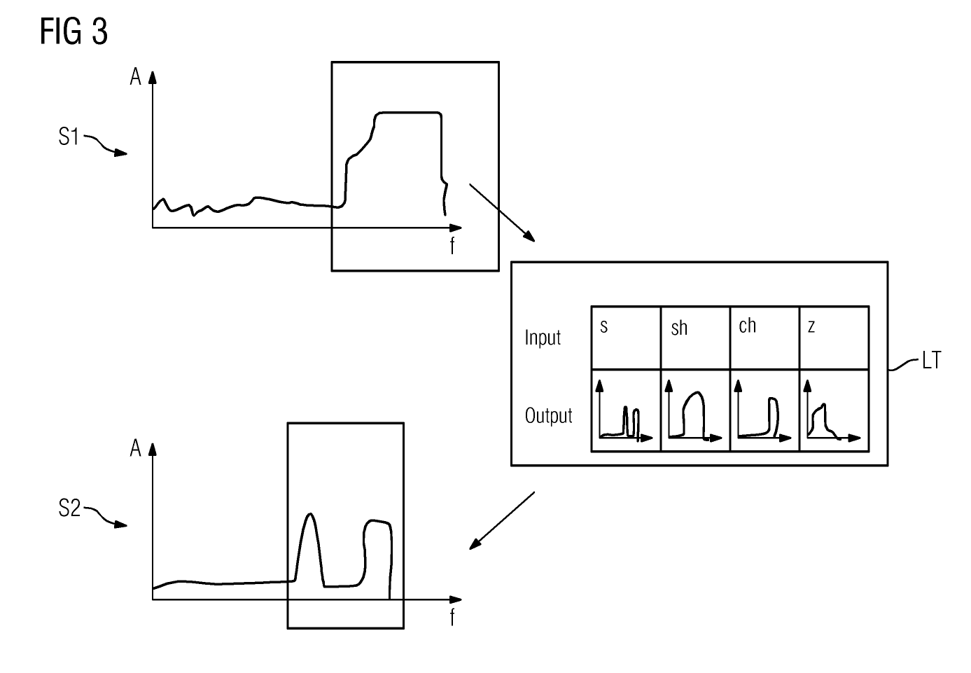

FIG. 3 explains the described procedure for code conversion again using the signal patterns. A spectrum S1 of an electrical input signal resulting from an acoustic input signal is first shown at a certain point in time. The sound detection device recognizes the consonant “s” in this signal. The output code shown with reference to the spectrum S2 is stored in the lookup table LT for this. The spectrum S2 is displaced towards lower frequencies compared with the spectrum S1—to compensate for the individual hearing loss of a specific user. The time signal belonging to the spectrum S2 finally replaces the time signal belonging to the spectrum S1, so that the consonant in question can be perceived by the user without the original acoustic signal being corrupted too much in the process.

The amplitude of the output code AK is advantageously adapted for the acoustic input signal with the voice signal contained therein so that an acoustic signal resulting from the original voice signal with the sounds or consonants contained therein and an acoustic signal, in which certain sounds or consonants are replaced by output codes AK in accordance with the invention, have at least essentially the same sound energy and therefore the impression of loudness remains at least essentially the same.

1. A hearing aid, comprising:
an input transducer for receiving an input signal and converting the input signal into an electrical input signal;
a signal processing unit for processing and frequency-dependent amplification of the electrical input signal and for generating an electrical output signal;
an output transducer for converting the electrical output signal into an output signal which can be perceived by a user as an acoustic output signal;
a sound detection device for recognizing sounds in a voice signal coming into the hearing aid;
a lookup table in which a specific output code is stored in each instance for certain sounds, a spectrum of the specific output code being narrower than a spectrum of an associated sound and/or the spectrum of the specific output code being displaced towards lower frequencies compared with the spectrum of the associated sound; and
a coding device, by means of which sounds contained in the electrical input signal can be replaced in each instance by the specific output code in the electrical output signal.

2. The hearing aid according to claim 1, wherein fricatives can be recognized by means of said sound detection device and output codes for the fricatives are stored in said lookup table.

3. The hearing aid according to claim 1, wherein the specific output codes can be adapted for an individual hearing loss of the user.

4. A method for operating a hearing aid, which comprises the steps of:
receiving in an input transducer an input signal and converting the input signal into an electrical input signal;
processing and frequency-dependent amplifying the electrical input signal in a signal processing unit for generating an electrical output signal by the further steps of:
recognizing sounds in a voice signal component of the input signal coming into the hearing aid;
assigning specific output codes to certain sounds and the specific output codes being stored in the hearing aid, a spectrum of the specific output code being narrower than a spectrum of an associated sound and/or the spectrum of the specific output code being displaced towards lower frequencies compared with the spectrum of the associated sound;
replacing the sounds contained in the electrical input signal in each instance by the associated output code in the electrical output signal; and
converting the electrical output signal into an output signal which can be perceived by a user as an acoustic output signal via an output transducer.

5. The method for operating the hearing aid according to claim 4, which further comprises assigning the specific output codes to certain fricatives and storing the specific output codes in the hearing aid, the fricatives contained in the electrical input signal are recognized by means of a sound detection device.

6. The method for operating the hearing aid according to claim 4, which further comprises adapting the specific output codes for an individual hearing loss of the user.
